(19) United States
(12) Patent Application Publication
(10) Pub. No.: US 2005/0134930 A1
(43) Pub. Date: Jun. 23, 2005

(54) Photographic printing system having recording medium writing device

(76) Inventors: Atsushi Nagamatsu, Wakayama-ken (JP); Nobuhiro Tsujioka, Wakayama-shi (JP)

Correspondence Address: FULBRIGHT & JAWORSKI, LLP, 666 FIFTH AVE, NEW YORK, NY, 10103-3198, US

(21) Appl. No.: 11/016,649

(22) Filed: Dec. 17, 2004

(30) Foreign Application Priority Data
Dec. 19, 2003 (JP) JP 2003-422033

(51) Int. Cl. H04N 1/21

(52) U.S. Cl. 358/302

(57) ABSTRACT

A photographic printing system includes an inputting device for inputting a photographic frame image and front printable information from an image storage medium storing therein both the photographic frame image for making a photographic print and the front printable information which can be printed on an image face of the photographic print together with the photographic frame image, a photographic printing device for making the photographic print based on the photographic image and the front printable information inputted by the inputting device and a writing device for writing digital data into a recording medium. The writing device writes into the recording medium the image data of the photographic frame image in an image file and writes also the front printable information actually used in making the photographic print in an information file separate from the image file in a format which allows the front printable information to be linked with the image data.

### BACKGROUND OF THE INVENTION

1. Field of the Invention

The present invention relates to a photographic printing system including an inputting device for inputting a photographic frame image and front printable information from an image storage medium storing therein both the photographic frame image for making a photographic print and the front printable information which can be printed on an image face of the photographic print together with the photographic frame image, a photographic printing device for making the photographic print, and a writing device for writing, into a recording medium, image data of the photographic frame image which was used in making the photographic print.

2. Description of the Related Art

Such photographic printing system as above is for use in making a photographic print based on a photographic frame image recorded by e.g. a digital camera. In making such photographic print, the photo lab or service shop provides a service, so-called “front printing service”, which prints, in the same image face of the print, not only the photographic frame image, but also “front printable information” such as a date of photography DD, as illustrated in an exemplary photographic print PP shown in FIG. 6.

In the case of a digital camera, such front printable information required for providing the above service is usually recorded and stored in a detachable storage medium (e.g. a memory card) storing image data of photographic frame images. And, within such medium, the front printable information may be stored separately from the photographic image data in a special file dedicated for ordering prints or may be recorded and stored together with the photographic image data in an image file in which the image data of photographic frame images are filed in a predetermined format.

On the other hand, as known from e.g. Japanese Patent Application “Kokai” No. 11-88577, the photo lab provides another type of service which records the image data used in making prints in a recording medium such as a CD-R and then provides this recording medium to the customer. In this case, the customer given the recording medium may place a reprint order with this recording medium in future. When the photo shop receives a reprint order in this form, the photo lab operating the photographic printing system will retrieve the photographic image data from the recording medium and make a photographic print (reprint) of the image based on the retrieved image data. In this case, the image in the original photographic print and the image reproduced in the reprint may not be in complete agreement with each other, due to lack of printing or reproduction of the front printable information (present in the original print) in the reprint. Hence, the customer may complain to the photo shop, saying the reprint being different from the original print.

### SUMMARY OF THE INVENTION

The present invention has been made in view of the above-described state of the art. A primary object of the present invention is to provide a photographic printing system which allows faithful reproduction of front print information added to the original photographic print in a reprint, without inviting disadvantageous complexity in handling.

For accomplishing the above-noted object, a photographic printing system, according to the present invention, comprises:
an inputting device for inputting a photographic frame image and front printable information from an image storage medium storing therein both the photographic frame image for making a photographic print and the front printable information which can be printed on an image face of the photographic print together with the photographic frame image;
a photographic printing device for making the photographic print based on the photographic image and the front printable information inputted by the inputting device; and
a writing device for writing digital data into a recording medium;
wherein the writing device writes into the recording medium the image data of the photographic frame image in an image file and writes also the front printable information actually used in making the photographic print in an information file separate from said image file in a format which allows the front printable information to be linked with the image data.

With the above-described construction, when image data of a photographic image to be reprinted is retrieved from the recording medium, the front printable information which was printed in the image face of the original print can be obtained automatically. Therefore, the invention has achieved the intended object of providing a photographic printing system which allows faithful reproduction of front printable information added to the original photographic print in a reprint, without inviting disadvantageous complexity in handling.

According to one preferred embodiment of the present invention, the information file written by the writing device contains only a portion of the front printable information which portion was actually printed in the original print. Namely, with respect to the writing of the information file in the recording medium, it is conceivable for the information file to contain the entire front printable information retrieved from the recording medium or to contain additionally an identification code for each piece of the front printable information, the identification code being indicative of whether this piece of information was actually printed in the original print or not. However, with the above-proposed construction that the writing device contains only a portion of the front printable information which portion was actually printed in the original print, in a reprinting operation, it is possible to identify the information to be front-printed only by reading the contents of the information file. Hence, the operation required for reproduction of the front printable information can be further simplified.

The present invention will be further advantageous if said image storage medium is a storage medium for storing photographic film images acquired by a digital camera or a photographic film having a magnetic recording function. That is, in the art of digital camera, the industry has proposed a system referred to as “DPOF” (Digital Print Order Format) (standardized format system proposed by Canon Inc., Eastman Kodak Company, Fuji Photo Film Co., Ltd. and Matsushita Electric Industrial Co., Ltd, the system allows recording in a recording medium customer's order information such as customer's specification of frames desired to be printed, the number of prints to be made from each desired frame from images acquired by a digital camera or a desired “comments” to be added to a frame, etc.). This system allows a customer to write such customer's print order information into an image storage medium, e.g. a “flash memory”, together with a photographic image. Then, the customer can advise a photo shop that such information as a date of photography (i.e. front printable information) should be printed in an image face (front face) of the photographic print together with the photographic image associated therewith. Further, as an alternative of such print order information described above, there is known a JPEG file according to EXIF (Exchangeable Image File Format), i.e. an “EXIF file”, which has been commonly established as an image data compiling format. This EXIF file can contain in a “tag” such additional information as a date of photography or customer's desired comments. In correspondence with these systems, the industry has come up with many photographic printing systems adapted therefor which allow printing of such front printable information contained in an image file in an image face of a photographic print together with the photographic image at the time of making the print. On the other hand, in the art of more “conventional” photography, there is available a new type of photographic film such as Ix240 type film, which is capable of magnetically recording such additional information (front printable information), e.g. a date of photography, in a magnetic recording track provided therein. And, there also exist many photographic printing systems adapted to this new type of film. In this case too, it is possible to obtain the actually printed front printable information from the film. Therefore, if the present invention is used in such cases for printing desired information in an image face of a photographic print by using a photographic image acquired by a digital camera or a photographic image recorded in the photographic film having the magnetic recording function, it is possible to obtain the actually printed front printable information from the information file in the storage medium or the magnetic data recording track of the photographic film. Hence, the faithful reproduction of such information can be readily realized in a reprint.

Advantageously, said recording medium is a CD-R. CD-R is one of well-known non-rewritable recording media which prohibit physical deletion of data once written therein and rewriting the data with new data and which are available at low costs. Of such non-rewritable recording media, the market price of CD-R has been reduced significantly. Therefore, by utilizing the CD-R medium, the service of providing a recording medium recording image data can be provided at extremely low costs. Hence, a photo shop can provide the data image providing service to a customer and receive a reprint order from a customer, by taking advantage of this inexpensive medium. And, in such case, the photo shop or the photo lab can automatically obtain, from the CD-R medium, the information to be reproduced in a reprint.

Further and other features and advantages of the present invention will become apparent upon reading following detailed description of preferred embodiments thereof with reference to the accompanying drawings.

### BRIEF DESCRIPTION OF THE DRAWINGS

FIG. 1 is shows a mode of installment of a photographic printing system relating to one embodiment of the present invention,

FIG. 2 is a perspective view showing an appearance of a print order receiving unit relating to the embodiment,

FIG. 3 is a block diagram of the photographic printing system relating to the embodiment,

FIG. 4 is a flowchart relating to the embodiment,

FIG. 5 is another flowchart relating to the embodiment, and

FIG. 6 shows an exemplary photographic print including front-printed photographic date information.

### DESCRIPTION OF THE PREFERRED EMBODIMENTS

Preferred embodiments of a photographic printing system relating to the present invention will be described with reference to the accompanying drawings.

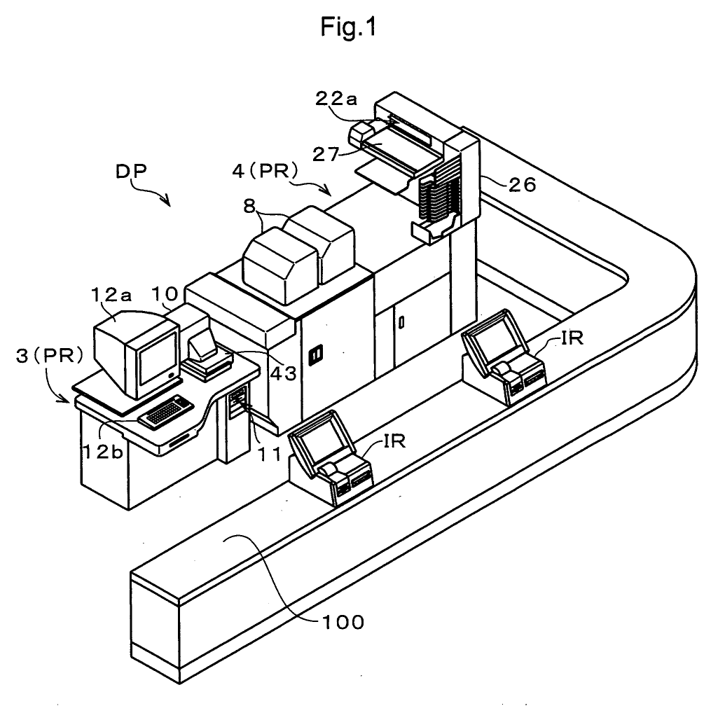

The photographic printing system DP relating to these disclosed embodiments is known as a “digital mini lab”. As can be seen from FIG. 1 showing an appearance of the system when installed at a photo shop, the system DP includes a print order receiving unit IR for receiving a customer's order for photographic prints by reading photographic image data recorded in various type of image storage media such as a memory card, a magneto-optic disk, a CD-R provided from a customer, a photographic printing device PR for making ordered photographic prints from the image data inputted by the print order receiving unit IR or from the image data recorded in a developed photographic film 1 (to be referred to as a “film 1” hereinafter), and a writing device CR for writing into a recording medium the image data of the images used by the photographic printing device PR in making the photographic prints. Control units or controllers incorporated in the respective devices above are connected to each other via a network.

In this embodiment, as an example of the recording medium into which the image data are written by the writing device CR (not shown in FIG. 1), there is employed a CD-R medium which is one type of non-rewritable recording media. Hence, in the following discussion, the writing device CR will be referred to as “CD-R writing device CR”.

In the case of the exemplary installment of the system shown in FIG. 1, the system includes two print order receiving units IR which are mounted on a counter 100 to be directly operable by a customer respectively.

[General Construction of Print Order Receiving Unit IR]

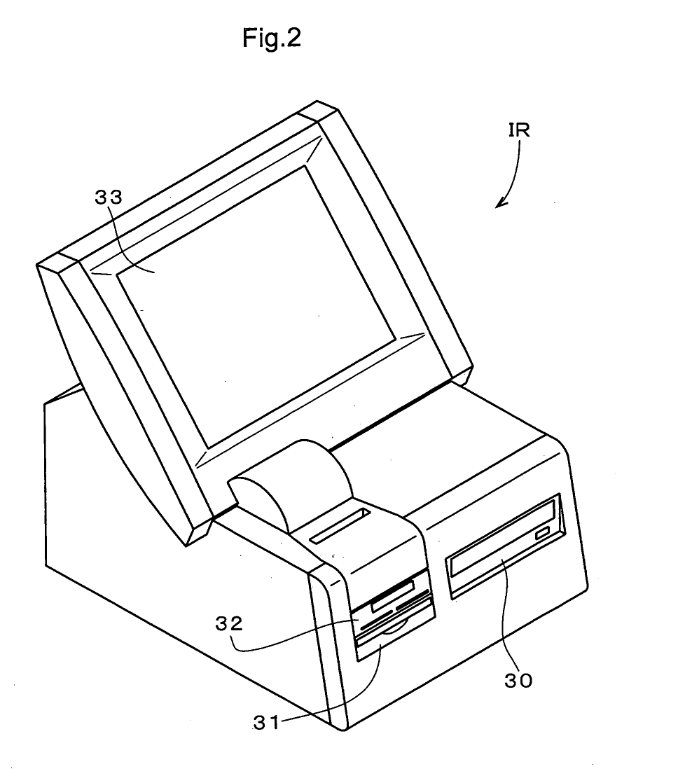

As shown in the perspective view of FIG. 2 showing its appearance, the print order receiving unit IR includes a CD-ROM drive 30 for reading image data recorded in a CD-R medium, an MO drive 31 for reading image data recorded in a magneto-optic disk, a memory card reader 32 for reading image data recorded in any one of large, medium and small sized memory cards available in the market, and a touch-panel type monitor 33 for displaying guidance information to a customer for his/her placing a print order. Further, though not shown, the print order receiving unit IR includes a controller for controlling the above-described components thereof.

[General Construction of Photographic Printing Device PR]

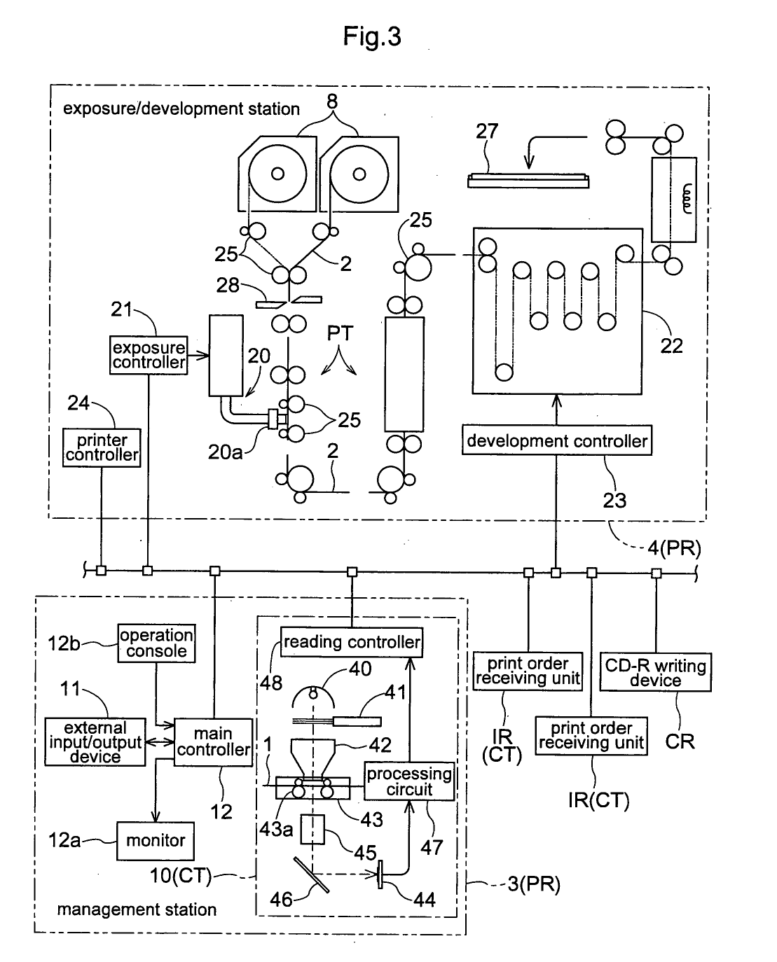

In this embodiment, the photographic printing device PR, as shown in FIGS. 1 and 3, includes, a management station 3 having a film scanner 10 for reading frame images of the developed photographic film 1 and configured for managing overall operations of the photographic printing system DP, and an exposure/development station 4 for making photographic prints by effecting exposure and development on a print paper 2 based on the image data to be exposed received from the management station 3.

[Construction of Management Station 3]

The management station 3, as shown schematically in the block diagram of FIG. 3, includes the film scanner 10 for reading frame images of the developed photographic film 1, an external input/output device 11 having the memory card reader, the MO drive, the CD-R drive etc., and a main controller 12 comprising a general-purpose computer system and configured for controlling the film scanner 10 and the external input/output device 11 and controlling also the entire photographic printing system DP. The main controller 12 is operably connected with a monitor 12a for displaying a simulated image simulating a finished print and various kinds of control information and an operation console 12b for allowing e.g. manual setting of exposure conditions and inputs of control information.

The film scanner 10 includes a halogen lamp 40, a light modulating filter 41 for balancing color components contained in a beam emitted from the halogen lamp 40, a mirror tunnel 42 for uniformly mixing the color components of the beam transmitted through the light modulating filter 41, a film carrier 43 having a conveying mechanism 43a, etc. and configured for setting the film 1 at a predetermined reading position, a CCD line sensor unit 44 for effecting photoelectric conversion of a frame image of the film 1, a lens 45 for focusing each frame image of the film 1 on the CCD line sensor unit 44, a mirror 46 for flexing an optical path by 90 degrees, a processing circuit 47 for effecting amplification and A/D conversion etc. of output signals from the CCD line sensor unit 44, and a reading controller 48 for controlling the entire film scanner 10. Though not shown, the film carrier 43 includes a magnetic recording head for reading magnetically recorded information from a photographic film such as the IX240 type, capable of magnetically recording information such as a date of photography (an example of “front printable information”) in a magnetic recording track provided in the film.

The CCD line sensor unit 44 includes three arrays of CCD line sensors juxtaposed along the width of the film 1, each line sensor having about 5000 units of CCD elements. In beam receiving faces of the respective arrays of CCD line sensors, red, green and blue color filters are formed for separating and detecting the color components of the frame image of the film 1 respectively.

Upon receipt of a reading instruction from the main controller 12, the reading controller 48 causes the film carrier 43 to initiate conveying of the film 1 set thereto and also outputs image data of each frame image outputted from the processing circuit 47 to the main controller 12.

Though not shown, the main controller 12 includes an image processing apparatus for processing the image data of the frame image of the film 1, the image data inputted from the external input/output device 11 or the image data inputted from the print order receiving unit IR into an image suitable for making a photographic print and generating image data to be exposed.

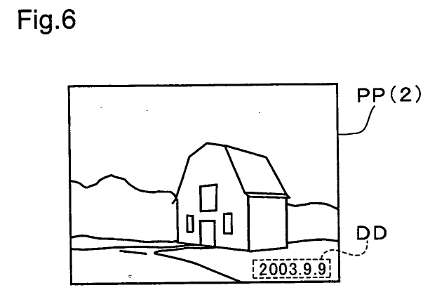

The photographic printing device PR is capable of effecting the so-called front printing operation for printing, together with a photographic image, a date of photography (an example of “front printable information”) in an image face (front face) of a photographic print PP as exemplarily illustrated in FIG. 6. For this front printing operation, the image processing apparatus included in the main controller 12 effects synthesis of the photographic image and the information to be front-printed (i.e. front printable information).

Incidentally, in the instant embodiment, a date of photography is explained as an example of such front printable information for front printing. However, other kind of information such as desired characters or graphic patterns etc. can be front printed also. Hence, in addition to the date of photography, the front printable information can be variety of information that a photographer can input as desired, such as his/her comments on the photography.

[General Construction of Exposure/Development Station 4]

As shown in the diagram of FIG. 3, the exposure/development station 4 includes, all accommodated in its housing, an exposure unit 20 having a PLZT print head 20a, an exposure controller 21 for controlling the exposure unit 20, a development unit 22 for developing the print paper 2 which has been exposed by the exposure unit 20, a development controller 23 for controlling conveying of a print paper within the development unit 22 and managing developing solutions, a printer controller 24 for controlling this entire exposure/development station 4, and a print paper conveying system PT for conveying the print paper 2 drawn out of a print paper magazine 8 mounted on the top face of the housing to the development unit 22 by means of e.g. a plurality of conveying rollers 25.

Outside the housing of the exposure/development station 4, as shown in FIG. 1, there are provided a sorter 26 for sorting print papers 2 developed and dried at the development unit 22 according to each customer's order and a conveyer 27 for conveying each print paper 2 discharged from a discharge opening 22a of the development unit 22 to the sorter 26.

Further, at a mid position in the conveying path of the print paper conveying system PT, there is provided a cutter 28 for cutting the elongate print paper 2 drawn out of the print paper magazine 8 into a predetermined print size.

[Operation for Making Photographic Print]

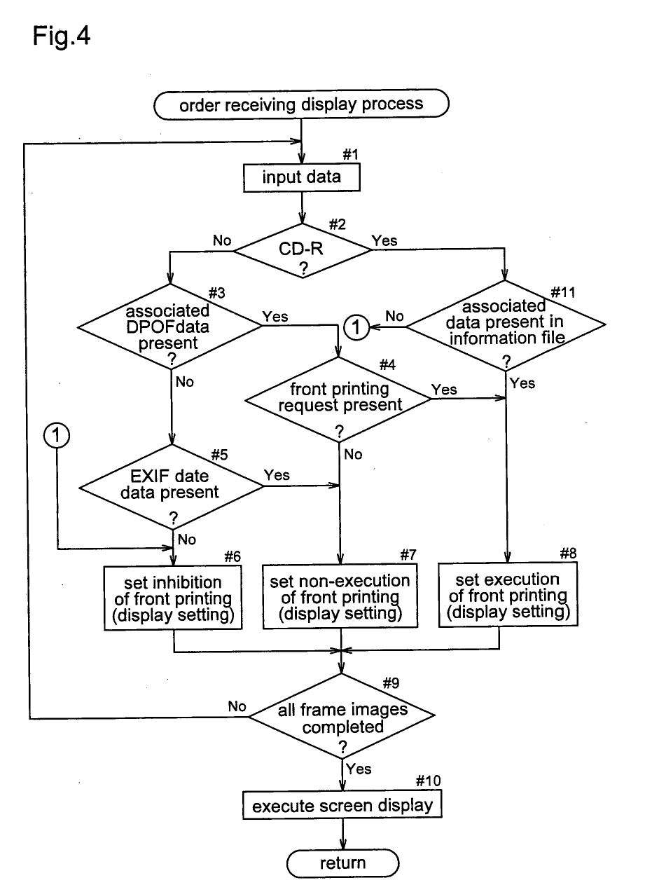

Next, a series of operations for making a photographic print by the photographic printing system DP having the above-described construction will be schematically explained. First, an operation for inputting the image data and the front printable information upon receipt of a customer's print order will be explained with reference to the flowchart of FIG. 4.

The customer can place his/her print order by operating the print order receiving unit IR by himself or herself as described hereinbefore. Needless to say, the customer can place such order in the conventional manner also by giving a memory card, a photographic film or CD-R medium to an operator of the photographic printing device PR or to a photo shop attendant.

The process illustrated in FIG. 4 is effected by the controller included in the print order receiving unit IR in case the customer places a print order by operating by himself or herself one of the print order receiving units IR mounted on the counter 100. Whereas, in case an operator inputs the print order by setting e.g. a memory card to the external input/output device 11, the process is effected by the main controller 12 of the management station 3.

As described hereinbefore, in this embodiment, the IX240 type film, the memory cards, the CD-R medium and the magneto-optic disk are described as the examples of the image storage media capable of storing therein images for making photographic prints and the front printable information associated therewith. For the purpose of simplicity of explanation, however, the process illustrated in FIG. 4 is based on an assumption that image data for making photographic prints and the front printable information are inputted from a memory card or from a CD-R.

That is, in addition to the print order receiving unit IR and the external input/output device 11, the film scanner 10 also functions as an “inputting device” CT for inputting image data for making photographic prints and the front printable information associated therewith.

The case when the customer self-operates the print order receiving unit IR will be explained first. The customer sets his/her memory card or CD-R storing photographic image data therein and gives an instruction for initiating the process from the monitor 33. With this, the process of FIG. 4 is initiated. If the set medium is a memory card and contains additional information, i.e. front printable information, according to DPOF, its information file is inputted and also the photographic image data is inputted one frame image after another (steps #1, #9).

In the above, the process determines whether the set image data source is a CD-R or a memory card (step #2). If it is determined as a memory card, the process also determines, for each inputted frame image whether there exists any effective DPOF additional information associated therewith (step #3).

If such DPOF additional information associated with the inputted frame image exists, then, the process checks whether execution of front printing of a photographic date is set in that information or not (step #4).

If the front printing of a photographic date is set, the process registers data such that an input setting for effecting front printing is made when the monitor 33 displays a screen for setting order conditions (step #8). Whereas, if the front printing of a photographic date is not set in the information, the process registers data such that an input setting for not effecting front printing is made when the monitor 33 displays the screen for setting order conditions (step #7).

Referring more particularly to the above-described data registrations, the screen display shown on the monitor 33 for setting of order conditions will include e.g. display of a check box and a display of characters of “effect front printing”. Then, if there exists the setting of front printing a photographic date in the DPOF additional information, a checked condition or check mark in the check box will be displayed as the initial condition. On the other hand, in the case of no setting of front printing a photographic date, an un-checked condition or absence of check mark in the check box will be displayed as the initial condition. In this manner, the original setting in the DPOF additional information will be effective unless the customer who operates the print order receiving unit IR intentionally changes the setting of “effect front printing”.

On the other hand, in case no such DPOF additional information associated with an inputted frame image exists (step #03), and if the inputted frame image is complied in the EXIF (Exchangeable Image File Format), then, the process checks whether EXIF information is present in a header area of this image file and the EXIF information, if any, contains data of a photographic date or not (step #05). If such photographic date data is contained, the process registers data such that an input setting for not effecting front printing is made when the monitor 33 displays the screen for setting order conditions (step #7). Whereas, if such photographic date data is not contained, the process registers data such that an input setting for inhibiting execution of front printing is made when the monitor 33 displays the screen for setting order conditions (step #6).

Referring more particularly to the above-described data registrations, e.g. the screen display shown on the monitor 33 for setting of order conditions will include the display of a check box and the display of characters of “effect front printing”. Then, if the EXIF information contains a photographic date data, an un-checked condition (i.e. absence of check mark) in the check box will be displayed as the initial condition. On the other hand, in case the EXIF information does not contain any photographic date data, the un-checked condition in the check box and a condition of inhibiting change in the check box will be displayed as the initial condition. In this manner, front printing operation of a photographic date is not effected under the default condition. When the EXIF information contains a photographic date data, the front printing operation of a photographic date is enabled when the customer operating the print order receiving unit IR intentionally places a check mark in the check box of “effect front printing”.

On the other hand, in case the source of image data for making a photographic print is not a memory card but a CD-R (step #2), the process checks whether this CD-R contains an information file containing the front printable information and this data file, if any, contains data of photographic date associated with the inputted frame image not (step #11). As will be detailed later, presence of such information file in the CD-R medium means that the image data which was printed in making the original photographic print was written into this CD-R and the customer is now ordering a reprint with this CD-R. In case such associated photographic date data is present, the process registers data such that an input setting for effecting front printing is made when the monitor 33 displays the screen for setting order conditions (step #8). Whereas, if no such data is present, the process registers data such that an input setting for inhibiting front printing is made when the monitor 33 displays the screen for setting order conditions (step #6).

Referring more particularly to the above-described data registrations, e.g. the screen display shown on the monitor 33 for setting of order conditions will include the display of a check box and the display of characters of “effect front printing”. Then, if the information file contains the photographic date data associated with the inputted frame image, a checked condition, i.e. presence of a check mark, in the check box will be displayed as the initial condition. On the other hand, if the information file does not contain any photographic date data associated with the inputted frame image, an un-checked condition, absence of a check mark, in the check box and the condition for inhibiting change in the setting of the check box will be displayed as the initial condition. In this manner, in case the information file contains the photographic date data associated with the inputted frame image, the front printing operation of the photographic date will be effected unless the customer intentionally deletes the check mark in the check box.

When the input operation of frame image and the data registration regarding need or no-need for front printing operation are completed for all frames of the film (step #9), the process then causes the monitor 33 to display reduced images of all inputted frame images and an input column or table (a table of input items) for receiving inputs relating to a number of prints desired and other order conditions desired by the customer (step #10). This display includes the display regarding the input conditions of front printing displayed and set as described above and includes also a display for prompting the customer to indicate whether he/she desires the service of writing into a CD-R the image data obtained after the photographic printing device PR has effected an appropriate image processing on the image data inputted thereto. Hence, the customer will input necessary data according to the screen display to the print order receiving unit IR. Then, when the customer has completed such input operations and inputs decision of the print order, the controller of the print order receiving unit IR reads the inputted order conditions (including the set condition in the check box regarding front printing). When the controller has read the image data of respective frame images and the order conditions data and found the setting of effecting front printing therein, the controller will transmit the photographic date data to the main controller 12 of the management station 3.

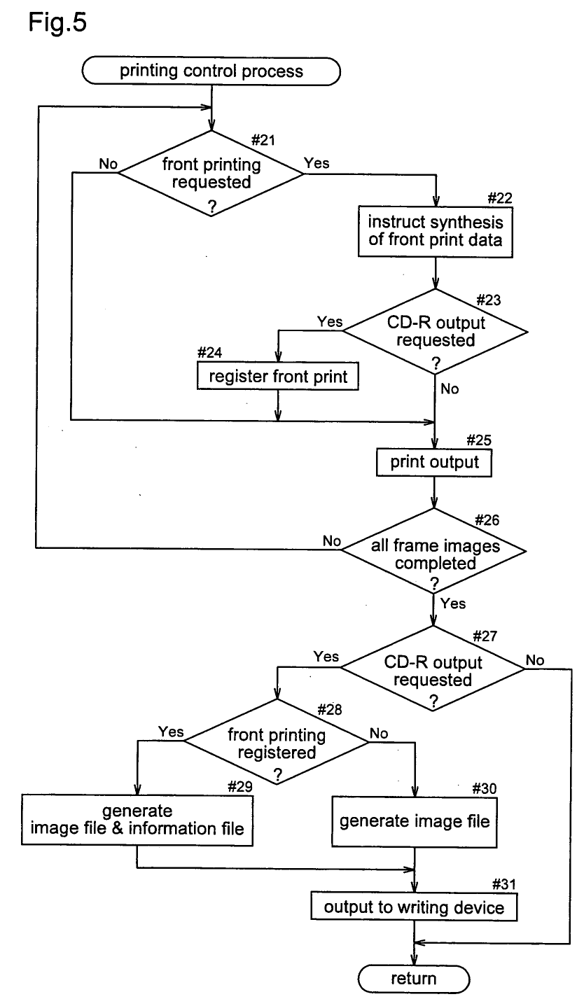

Next, the subsequent process effected by the main controller 12 after the above-described reception of the image data of the respective frame images and the customer's order conditions data will be discussed with reference to the flowchart shown in FIG. 5.

The photographic printing device PR is configured to display a simulated image of each frame image on the monitor 12a to allow an experienced operator to effect precision color adjustment of the image. Upon completion of this manual operation, the process shown in FIG. 5 is initiated.

First, for each frame image, the process checks whether the order conditions data received from the print order receiving unit IR includes the setting of effecting front printing or not (step #21). In the case of presence of this setting for effecting front printing (i.e. a check mark is present in the check box), the process gives an instruction to the image processing apparatus included in the main controller 12 for synthesizing the photographic date data as the front printable information with the image data of the frame image (step #22).

In this case of presence of setting for effecting front printing, the process checks also whether output of the printed images to a CD-R is requested or not (step #23). If this is requested, the process registers data such that front printing is to be effected for that frame image (step #24), and then transmits the image data for which the appropriate image processing has been completed and synthesized with the photographic date data to the exposure/development station 4 (step #25) to be printed on the print paper 2.

In the case of absence of setting for effecting front printing, the process immediately transmits the photographic image data after completion of appropriate image processing to the exposure/development station 4 (step #25) to be printed on the print paper 2.

When the above-described process has been completed for all of the frame images (step #26), if there exists request for outputting the printed images to a CD-R medium (step #27), and if there exists any frame image on which the data registration for effecting front printing was effected at step #24 (step #28), then, the process makes an information file consisting of the photographic date data for that frame image and data indicative of correlation between this photographic date data and the frame image and compiles the image data of each frame image (i.e. image data before synthesis with the photographic date) into an image file in a general-purpose format such as JPEG (step #29) and outputs this information file and the image file to the CD-R writing device CR (step #31). Upon receipt of the information file and the image file prepared as separate files as above, the CD-R writing device CR writes both these files in a blank CD-R medium set thereto.

On the other hand, if no front printing data registration was effected for any frame image at step #24, the process compiles only the photographic image file (step #31) and outputs this image file to the CD-R writing device CR. Upon receipt of this image file data, the CD-R writing device CR writes the image file in the blank CD-R medium set thereto.

That is to say, the information file to be written in the CD-R medium is configured to contain only a portion of the front printable information (in this embodiment “photographic date”) which portion was actually printed when the original photographic print was made. Hence, the information file containing front printable information is constructed such that the actually printed front printable information can be identified.

The information file prepared as described above will be used in the process subsequent to step #11 in FIG. 4. So that, when a customer orders a reprint with the CD-R containing this information file, the original photographic print (i.e. the photographic print made when the image file was written in the CD-R) can be reproduced faithfully in the reprint.

The foregoing discussion relates to the case when a customer himself or herself operates the print order receiving unit IR for ordering prints. The same process will be effected also when an operator of the photographic printing device PR inputs image data to be printed to the external input/output device 11.

Further, the same process may apply also to a case when front printing is effected for the front printable information magnetically recorded in the IX240 type film 1 and an information file is made from this front printed front printable information and this information file is written together with an image file in a CD-R. Namely, when the invention is applied to such IX240 type film 1, the information magnetically recorded in this film 1 can be processed just like the additional information according to DPOF. In this case, at step #3 shown in FIG. 4 and effected at the main controller 12, “DPOF additional information” will be changed to “information magnetically recorded in IX240 type film 1”.

The image data for exposure transmitted from the management station 3 to the exposure/development station 4 as described above will be stored in a memory incorporated in the printer controller 24 of the exposure/development station 4.

Upon detection of conveyance of a front end of the print paper 2 to a predetermined exposure start position based on conveyance information on the print paper 2 transmitted from the print paper conveying system PT, the printer controller 24 instructs the exposure controller 21 to start an exposure operation and sequentially transmits exposure image data to the exposure controller 21 at a speed corresponding to an exposing speed of the exposure unit 20.

Then, the exposure controller 21 activates the respective optical shutters of the PLZT print head 20a based on the received exposure image data, thereby to form a latent image of the print image on the print paper 2.

The print paper 2 exposed at the exposure unit 20 is then conveyed by the print paper conveying system PT to the development unit 22, in which the paper is developed as it is caused to pass respective development solution tanks. Thereafter, the developed print paper 2 is dried and then discharged from the discharge opening 22a onto the conveyer 27 and sorted by the sorter 26 according to each customer's order.

As shown in FIG. 6, in the photographic print PP finished in the manner described above, the photographic date information DD as an example of the front printable information is printed on the image face of the print together with a photographic image. In this way, the original photographic print can be reproduced faithfully in the reprint made from the CD-R medium as well.

### Other Embodiments

Next, other embodiments of the invention will be described.

(1) In the foregoing embodiment, the information file to be written in a CD-R contains only a portion of the front printable information (in the disclosed embodiment, “photographic date”) which portion was actually printed in the original photographic print, so that the information file containing the front printable information is constructed so as to identify the front printable information actually printed in the original print. Alternatively, the information file can contain the entire print printable information in combination and correlation with an identification mark indicative of which portion of the front printable information was actually printed in the original photographic print.

(2) In the foregoing embodiment, the photographic printing device PR employs the exposure method using the PLZT optical shutter type having the PLZT print head 20a. In this invention, the exposure method is not limited thereto, but can be a laser exposure using a laser beam for scanning/exposure. Further, the printing method can be a non-exposure printing method such as the ink jet printing.

(3) In the foregoing embodiment, the CD-R medium as an example of non-rewritable recording media was employed as a recording medium to be written by the writing device CR. Instead, any other type of non-rewritable recording medium such as a DVD-R medium, or even a writable recording medium such as the magneto-optic disk can be employed as well.

1. A photographic printing system comprising:
an inputting device for inputting a photographic frame image and front printable information from an image storage medium storing therein both the photographic frame image for making a photographic print and the front printable information which can be printed on an image face of the photographic print together with the photographic frame image;
a photographic printing device for making the photographic print based on the photographic frame image and the front printable information inputted by the inputting device; and
a writing device for writing digital data into a recording medium;
wherein the writing device writes into the recording medium image data of the photographic frame image in an image file and writes also the front printable information actually used in making the photographic print in an information file separate from said image file in a format which allows the front printable information to be linked with the image data.

2. The photographic printing system according to claim 1, wherein the information file written by the writing device contains only a portion of the front printable information which portion was actually printed in the original print.

3. The photographic printing system according to claim 1, wherein said image storage medium is a medium for storing photographic frame images acquired by a digital camera or a photographic film having magnetic recording function.

4. The photographic printing system according to claim 1, wherein said recording medium is a CD-R medium.
